(19) United States
(12) Patent Application Publication
(10) Pub. No.: US 2026/0300592 A1
(43) Pub. Date: Oct. 1, 2026

(54) LOGICAL TIME DIVISION MULTIPLEXING OF DIGITAL LOGIC DESIGNS

(71) Applicants: VeriSilicon Microelectronics (Shanghai) Co., Ltd., Shanghai (CN); VeriSilicon Holdings Co., Ltd., George Town (KY)

(72) Inventor: Jen-Te Lee, Cupertino, CA (US)

(21) Appl. No.: 19/096,993

(22) Filed: Apr. 1, 2025

(51) Int. Cl. G06F 30/327

(52) U.S. Cl. CPC G06F 30/327

(57) ABSTRACT

N instances of a design including stateless combinational logic and data storage, e.g., flip-flops, are replaced with a logically time-division multiplexed (TDM) design including a single instance of the combinational logic and N instances of the data storage chained together such that for all but the first instance, an instance will receive the output of a preceding instance. The N instances of the data storage are driven by a sub-divided clock that generates N clock cycles for each clock cycle of an external clock. The output of the last instance is input to the combinational logic and the first instance receives an output of the combinational logic. A bridging circuit serializes input data and deserializes the outputs of the combinational logic for each clock cycle of the sub-divided clock. A single RAM instance of the design may likewise be modified for use in the TDM design.

### FIELD OF THE INVENTION

The present invention relates generally to systems and methods for designing logic circuits.

### BACKGROUND OF THE INVENTION

Digital logic is often described using specialized programming languages, often referred to hardware description languages (HDL), such as VERILOG and very high-speed integrated circuit hardware description language (VHDL). As for other types of programming, parts of a design may be described as instances of a sub-design, such as a separate file of HDL code. This helps a designer abstract elements of a design in order to implement complex architectures.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a simplified representation of digital logic design that may be converted using logical time-division multiplexing (TDM) in accordance with an embodiment of the present invention;

FIG. 2 is a schematic block diagram illustrating conversion of a state of a digital logic design to a plurality of logical TDM states in accordance with an embodiment of the present invention;

FIG. 3 is a schematic block diagram of a logical TDM design in accordance with an embodiment of the present invention;

FIG. 4A is a schematic diagram illustrating a first approach for implementing a memory for a logical TDM design in accordance with an embodiment of the present invention;

FIG. 4B is a schematic diagram illustrating a second approach for implementing a memory for a logical TDM design in accordance with an embodiment of the present invention;

FIG. 5 is a schematic block diagram illustrating bridging logic for a logical TDM design in accordance with an embodiment of the present invention;

FIG. 6 is a timing diagram illustrating the function of bridging logic for a logical TDM design in accordance with an embodiment of the present invention;

FIG. 7 is a schematic block diagram of a computing device that may be used to implement the systems and methods described herein.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

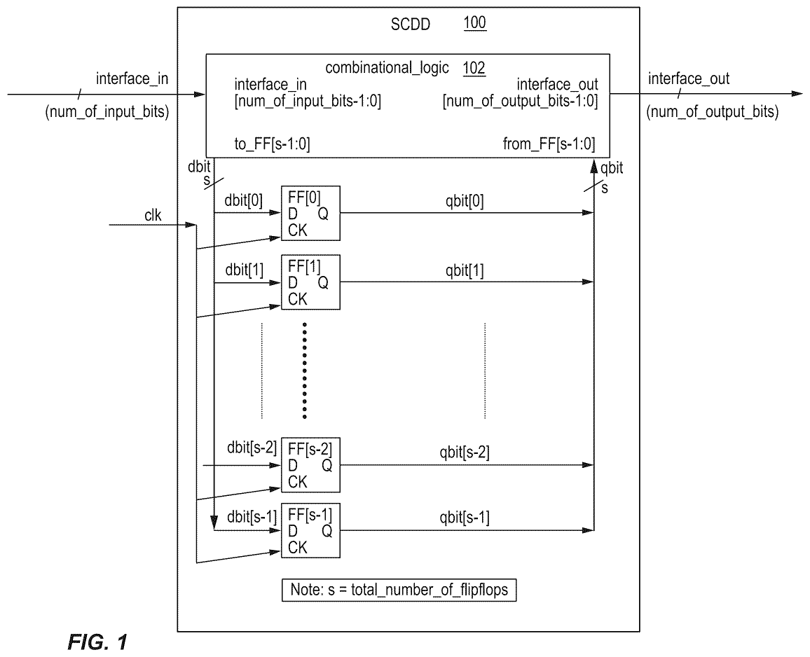

Referring to FIG. 1, a digital logic design may be described in a programming language used to describe an electronic circuit, such as a hardware description language (HDL). For example, the digital logic design may be defined using VERILOG, VHDL, or other HDL. The digital logic design may describe logic that may be implemented using features formed in an application-specific integrated circuit (ASIC), a configuration of a field programmable gate array (FPGA), or a configuration of some other type of configurable hardware device.

The approach described herein is particularly applicable to a single clock-driven digital design (SCDD) 100. Most SCDDs 100 may be characterized as having combinational logic 102 that takes inputs and produces outputs as a logical function of the inputs. The combinational logic 102 does not have a persistent state but merely produces outputs as a function of inputs after a delay for signals to propagate through the combinational logic 102.

The SCDD 100 may also be characterized as having data storage capable of storing a plurality of states that are set by the combinational logic 102 and that persist from one clock cycle to the next. In the illustrated example, each state in the data storage is represented as a flip-flop (FF), e.g., the illustrated s flip-flops FF[0] to FF[s−1] each having a data input D, a clock input CK, and an output Q. For each clock cycle (e.g., on each rising edge), each flip-flop FF will change its state such that the output Q becomes the level (1 or 0) on the input D and maintains that state until the level of the data input D is different on a subsequent rising edge. In the examples described herein, a change in state in response to a rising edge is assumed with the understanding that designs transitioning on a falling edge would function in a like manner.

In the SCDD 100, the state input D of each FF[i], i=0 to s−1, is coupled to a state interface output dbit[i], i=0 to s−1, from the combinational logic 102 and will therefore store the value asserted on dbit[i] as the state thereof in response to a rising edge on the clock line clk connected to the clock inputs CK of the FF[i]. In addition, the state output Q of each FF[i] is connected to a corresponding state interface input qbit[i], i=0 to s−1, of the combinational logic 102.

The combinational logic 102 further receives one or more input bits (interface_in) from a source external to the SCDD and generates one or more output bits (interface_out) supplied to a recipient device external to the SCDD. There may be any number of input bits (num_of_input_bits) and any number of output bits (num_of_output_bits).

The combinational logic 102 may perform logical operations (AND, OR, NAND, NOR, MUX, etc.) with respect to the input bits interface_in and the inputs qbit[i]. The combinational logic produces output signals on interface_out and dbit[i]. The values currently asserted on dbit[i] are stored by FF[i] in response to a rising edge on the clock line clk.

The illustrated SCDD 100 is a simplified abstraction of any SCDD. The components implementing the combinational logic 102 and flip-flops FF[i] may be distributed throughout a digital logic design, including in different instances of sub-designs incorporated into the digital logic design. However, any SCDD may be characterized as having the architecture of the illustrated SCDD 100.

In some digital logic designs, there may be many instances (N) of the same SCDD 100. Fully instantiating each SCDD 100 will therefore result in instantiating the identical combinational logic 102 and flip-flops FF[i] N times. This occupies area of a silicon die, gates of an FPGA, or space in whichever device is being used to implement the digital logic design. In some applications, space is limited, such as in embedded devices. Using the approach described herein, N instances of an SCDD 100 may be converted into a logical time division multiplexed (TDM) SCDD that occupies significantly less space, uses less gates, or otherwise.

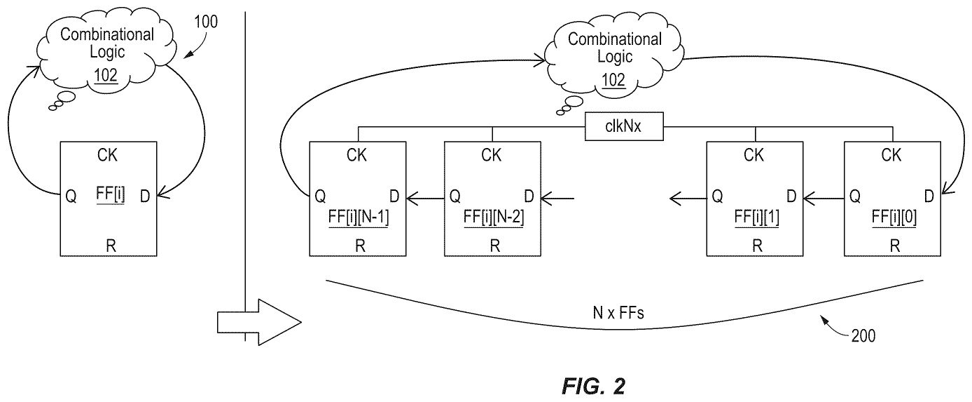

FIG. 2 illustrates an approach for converting the design of the SCDD 100 into a design including N logical time division multiplexed (TDM) instances of the SCDD (“the TDM design 200”). A single instance of the combinational logic 102 is included in the TDM design 200. For each flip-flop FF[i] in the SCDD 100, a set of N flip-flops FF[i][j], j=0 to N−1 will be included in the design. The set of N flip-flops FF[i][j] may be arranged in a chain of flip-flops. For example, the input D of the first flip-flop FF[i][0] is connected to the output dbit[i] of the combinational logic 102, the inputs D of the remaining flip-flops are connected to the output of a preceding flip-flop: the input D of flip-flop FF[i][j] is connected to the output Q of flip-flop FF[i][j−1]. The output Q of the last flip flop FF[i][N−1] is connected to the input qbit[i] of the combinational logic.

The clock inputs CK of the flip-flops FF[i][j] are connected to a sub-divided clock signal clkNx, i.e., a modified version of a clock external to the TDM design 200 in which there are N clock cycles for every one clock cycle of the external clock. In an aspect, clock signal clkNx is generated via a clock multiplier that accepts the external clock as input. The clock multiplier may include, for example, a phase-locked loop to ensure that the external clock signal and the clkNx signal are substantially phase-aligned.

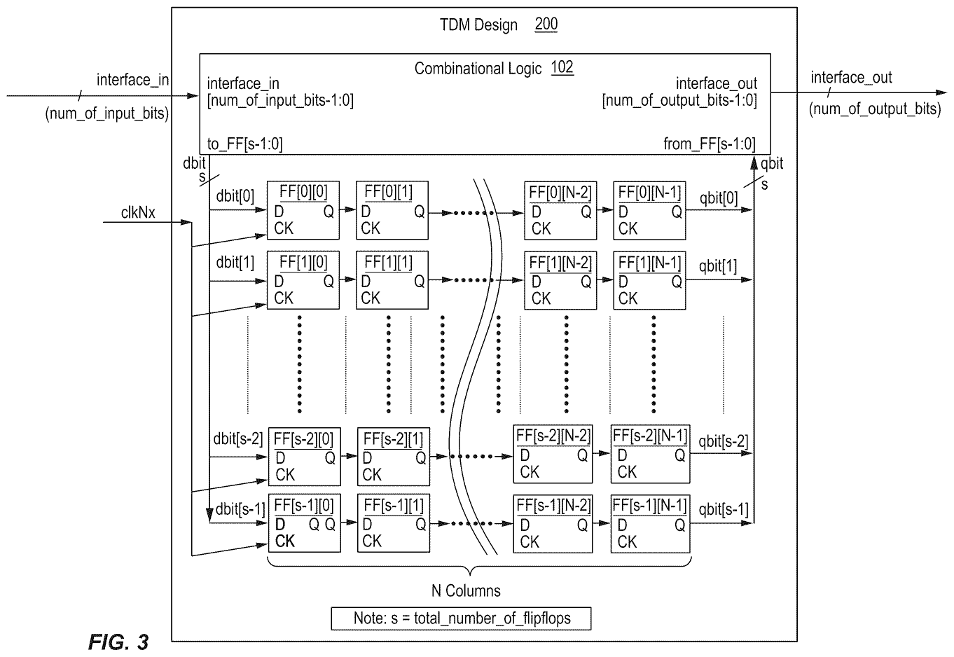

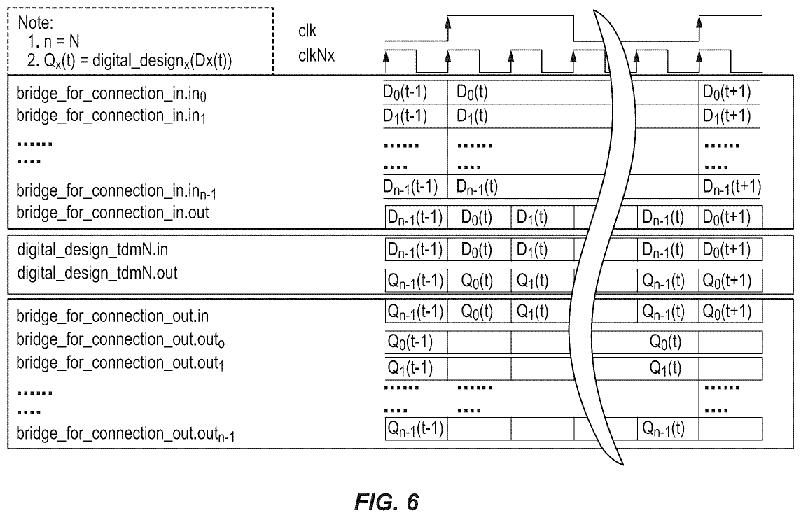

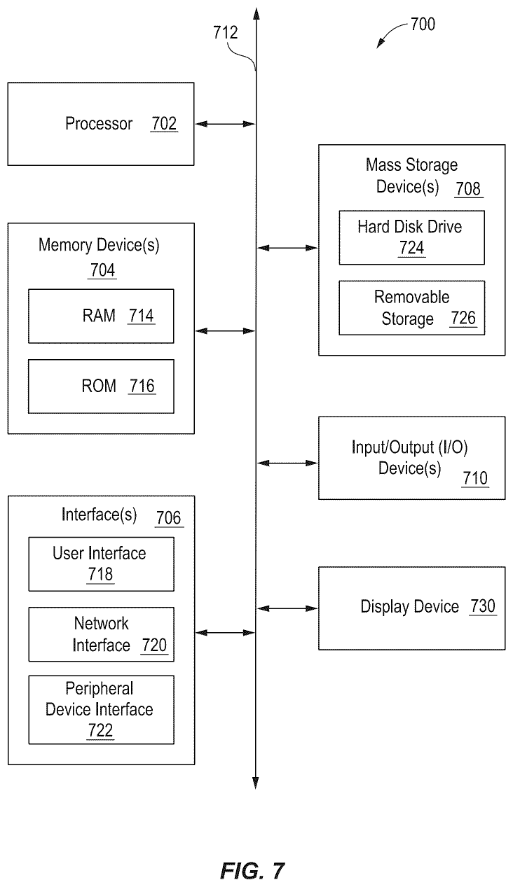

Referring to FIG. 3, in the TDM design 200, the output of the combinational logic 102 at any given moment in time will be a function of the outputs Q of the last flip-flops FF[i][N−1] and the signals on the external inputs interface_in. The output of the combinational logic 102 at any given moment in time will be asserted on the external outputs interface_out. The output of dbit[i] will be stored in the first flip-flop FF[i][0] upon each rising edge of the sub-divided clock clkNx. A bridging circuit (see FIGS. 6 and 7) may be used to assemble the outputs of the combinational logic 102 into a set of outputs corresponding to the N instances of the SCDD 100 implemented by the TDM design 200.

As is apparent in FIGS. 2 and 3, the set of N flip-flops FF[i][j], j=0 to N−1 pass a state from the first flip-flop FF[i][0] to the last flip-flop FF[i][N−1] in N clock cycles such that the input latched into the first flip-flop FF[i][0] at a clock cycle C[0] will be output from the output Q of the last flip-flop FF[i][N−1] at clock cycle C[N]. Accordingly, every Nth clock cycle, the inputs (interface_in and qbit[i]) and outputs (interface_out and dbit[i]) of the combinational logic 102 will correspond to the same instance j of the SCDD 100 and the values latched into the first flip-flop FF[i][0] every Nth clock cycle will likewise correspond to instance j.

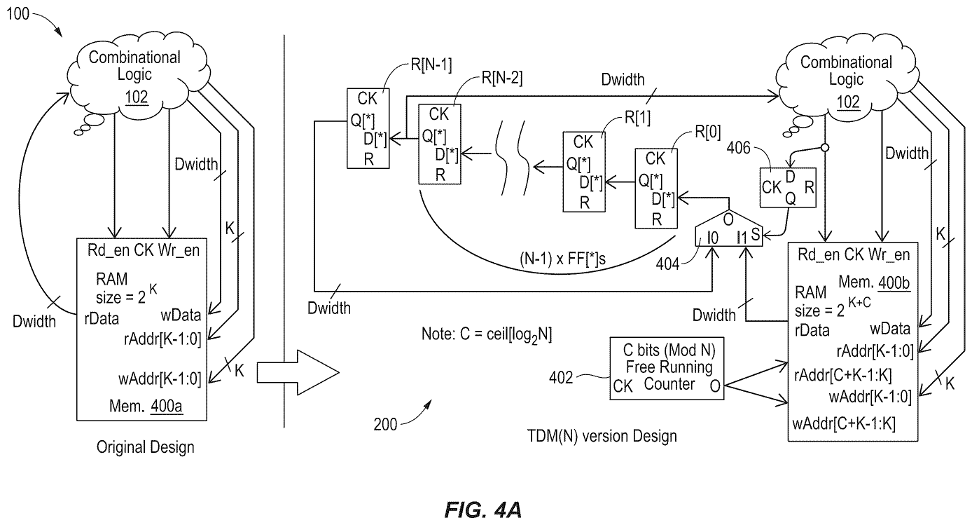

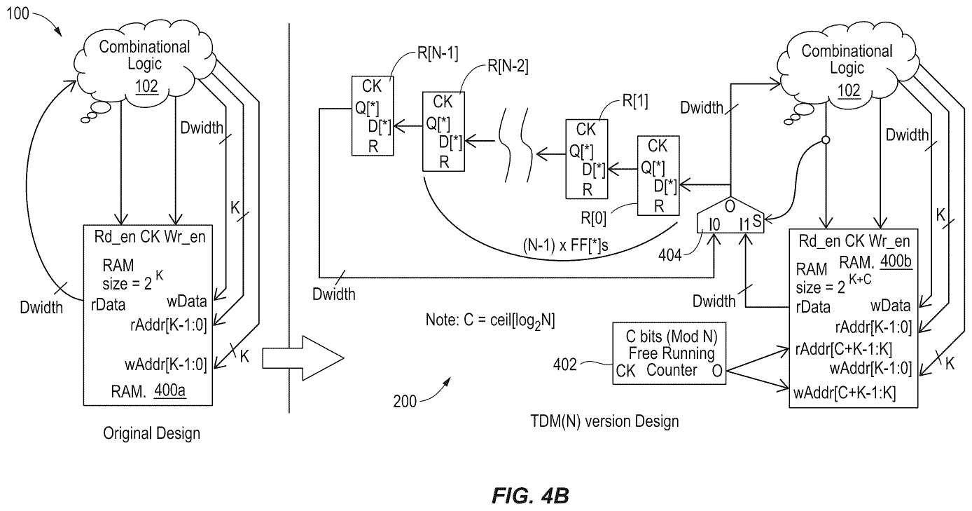

Referring to FIG. 4A, some SCDDs 100 may include a memory for storing values at addresses that may then be read from the addresses. In its simplest form, a memory may be implemented as an array of flip-flops as described above. In other applications, a memory may be a random-access memory (RAM) 400a that stores data at addresses within the RAM 400a and reads the memory from an address within the RAM 400a. In the illustrated implementation, the RAM 400a stores data in words having a width Dwidth, e.g., 8, 16, 32, 64, or some other number of bits. The RAM 400a includes a data input wData for receiving data written to the RAM 400a and a data output rData for outputting data read from the RAM 400a. The RAM 400a may include a write enable input Wr_en, a read enable input Rd_en, a write address input wAddr[K−1:0], where K is the number of bits in each address, a read address input rAddr[K−1:0], and a clock input CK.

When the write enable input Wr_en is asserted, the data present on wData is stored in the RAM 400a at the address on wAddr[K−1:0] in response to a rising clock edge on the clock input CK. When the read enable input Rd_en is asserted upon receiving a rising clock edge on the clock input CK, the data stored in the RAM 400a at the address on rAddr[K−1:0] is retrieved and is output on the data output rData upon receiving the next rising clock edge on the clock input CK.

The RAM 400a may be modified to obtain a RAM 400b for use in the TDM design 200 and the other illustrated components of the TDM design 200 may be used to enable the RAM 400b to be used with a single instance of the combinational logic 102.

The RAM 400b may be modified relative to the RAM 400a in some or all of the following ways:
The size of the ram may be increased from 2\hat{ }K to 2\hat{ }(K+C), where C is ceil(log₂(N)) (i.e., the original size multiplied by 2\hat{ }C).
The width of the read address input rAddr and write address input wAddr may be increased from K to K+C (rAddr[K−1:0] to rAddr[C+K−1:0] and wAddr[K−1:0] to wAddr[C+k−1:0]).

Other than these modifications, the RAM 400b may function identically to the RAM 400a. Accordingly, the TDM design 200 may use a predefined wrapper defined in a library of predefined designs available for use by a designer.

The write data input wData and the read data output rData may remain unchanged, e.g., have the same width Dwidth. The inputs to the read address input rAddr may be a concatenation of the output of counter 402 and the read address output by the combinational logic 102, the most significant bits (MSB) of the concatenation being the output of the counter 402. The inputs to the write address input wAddr may be a concatenation of the output of the counter 402 and the write address output by the combinational logic 102, the most significant bits (MSB) of the concatenation being the output of the counter 402.

The counter 402 may be a free running counter with a modulo N operation. The output O of the counter 402 counts up for each rising edge of the sub-divided clock clkNx received at the clock input CK of the counter 402 until reaching N−1, at which point the output O will return to 0 on the next rising edge. The output O may be C bits wide.

The RAM 400a may be expected to function such that (a) upon receiving a rising clock edge with the read enable input Rd_en asserted, the read data is available on the output rData on the next rising clock edge and (b) the data will remain available until the read enable input Rd_en is again asserted during a rising clock edge. The TDM design 200 may therefore include components to ensure that the RAM 400b performs these functions correctly with respect to each instance j of the TDM design 200.

For example, there may be N registers R[j], j=0 to N−1. The registers R[j] may be viewed as arrays of flip-flops having inputs D, outputs Q, and clock inputs CK, the number of flip-flops in each array being equal to Dwidth. Accordingly, upon receiving a rising edge on the clock input CK, the values on the D inputs of the array will be latched in and output on the outputs Q until different values are asserted on the inputs D during a rising edge on the clock input CK. The inputs D of each register R[j], j=1 to N−1 are coupled to the outputs Q of a preceding register R[j−1].

The inputs D of the register R[0] may be coupled to the output of a multiplexer 404. The select line of the multiplexer 404 may be coupled to the output Q of a flip-flop 406. The input D of the flip-flop 406 may be coupled to the read enable input Rd_en of the RAM 400b. The flip-flop 406 further includes a clock input CK coupled to the sub-divided clock clkNx.

The inputs of the multiplexer 404 may be coupled to the read data output rData (e.g., coupled to the 1 input of the multiplexer 404) and to the outputs Q of the last register R[N−1] (e.g., coupled to the 0 input of the multiplexer 404).

The operation of the TDM design 200 with respect to the RAM 400b is described below with reference to rising edges 0 to N of the sub-divided clock clkNx and rising edges a×N, where a is an integer.

When the combinational logic asserts the read enable input Rd_en during a rising clock edge of the sub-divided clock clkNx (rising edge 0), the flip-flop 406 will latch this assertion to its output Q and the RAM 400b will perform a read of data at the concatenation of the output O of the counter 402 and the address asserted on the read address input rAddr. The read data will be asserted on the read data output rData on the next rising clock edge of the sub-divided clock clkNx (rising edge 1).

Since the output of the flip-flop 406 is asserted (e.g., 1) in response to prior assertion of the read enable input Rd_en, the select line input of the multiplexer 404 will select the 1 input to pass through to the first register R[0], i.e., the value output by the read data output rData. The first register R[0] will then latch in this value to its outputs Q in response to rising edge 1. Upon receiving the second clock edge, if the read enable input is not asserted by the combinational logic 102, the flip-flop 406 will latch a 0 to its output Q, causing the multiplexer 404 to switch to selecting the 0 input (the output of the last register R[N−1].

With each subsequent rising edge (rising edges 2 to N−1) of the sub-divided clock clkNx, the data latched into the first register R[0] is passed along the registers R[1] to R[N−2]. Accordingly, when rising edge N−1 occurs, the read data will be at the outputs Q of the register R[N−2] (the penultimate register) and will be input to the combinational logic 102 in place of the read data output rData of the RAM 400b. When rising edge N occurs, the read data will be at the outputs Q of the last register R[N−1]. If the output of the flip-flop 406 is 0 upon receiving rising edge N (the read enable input Rd_en was not asserted on a preceding rising edge N−1), the 0 input of the multiplexer 404 is therefore selected and the outputs Q of the last register R[N−1] will be latched into the first register R[0] upon occurrence of rising edge N+1.

Accordingly, absent assertion of the read enable input Rd_en on rising edge N or other rising edge a×N, the read data will continue to be passed along the registers R[0] to R[N] and from R[N] to R[0]. The read data will therefore be at the outputs of the register R[N−2] every rising edge a×N of the sub-divided clock clkNx until rising edge (a+1)×N following assertion of the read enable input Rd_en during a rising edge a×N. When the read enable input Rd_en is asserted on a rising edge a×N following rising edge 0, the process repeats, e.g., the rising will be rising edge 0 in a subsequent iteration of the process described above.

Referring to FIG. 4B, some RAM 400a may output data on the read output rData during the same clock cycle, during whose rising edge the read enable line Rd_en was asserted. For such applications, the TDM design 200 may be modified with respect to a RAM 400b. The modifications of the RAM 400b relative to the RAM 400a may be the same as for the embodiment of FIG. 4A. Likewise, like numbered elements of FIG. 4B may function as described with respect to FIG. 4A.

In the embodiment of FIG. 4B, the flip-flop 406 may be eliminated and the output of the multiplexer 404 may be input to the combinational logic 102 as the read data output by from the read data output rData. The select line of the multiplexer 404 may be coupled to the read enable input Rd_en. Accordingly, when the read enable input Rd_en is asserted, the 1 input of the multiplexer 404 is coupled to the output, i.e., the read data from the read data output rData.

The output of the multiplexer 404 is likewise coupled to the input D of the first register R[0]. The read data will therefore be latched into the first register R[0] upon receiving a rising clock edge while the read enable input Rd_en is asserted. When the read enable input Rd_en is not asserted, the 0 input of the multiplexer 404 is coupled to the output, i.e., the outputs of the last register R[N−1] are coupled to the inputs of the first register R[0]. When the read enable input Rd_en is not asserted, the output of the last register will therefore be latched into the first register R[0] upon receiving a rising clock edge. The read data will therefore circulate through the registers R[0] to R[N−1] and be output from the multiplexer 404 every Nth clock cycle until the read enable input Rd_en is asserted during a rising clock edge.

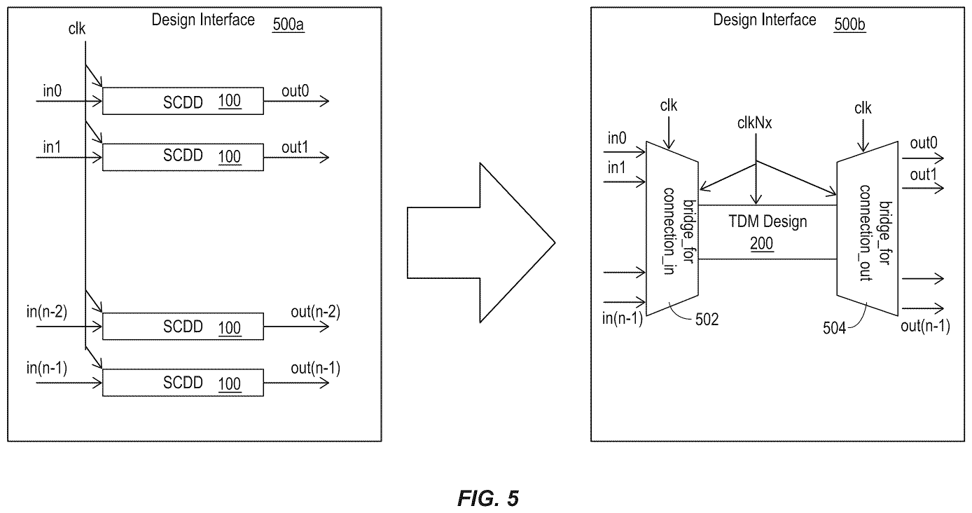

Referring to FIG. 5, a plurality of instances of an SCDD 100 may be used in combination with a design interface 500a that supplies a clock signal and the inputs in0 to in(n−1) to each instance of the SCDD 100 (e.g., the interface_in lines of each SCDD 100) and receives the outputs out0 to out(n−1) from each instance of the SCDD (e.g., the interface_out lines of each SCDD 100).

The design interface 500a may be modified to achieve a design interface 500b for use with the TDM design 200 replacing the plurality of instances of the SCDD. The design interface 500b may include an input bridging circuit 502 that receives the inputs in0 to in(n−1) for the plurality of instances of the SCDD 100 replaced by the TDM design 200 and outputs the outputs out0 to out(n−1) for the plurality of instances of the SCDD 100 replaced by the TDM design 200. The design interface 500b may receive or generate the external clock clk and receive or generate the sub-divided clock clkNx. The operation of the input bridging circuit 502 and the output bridging circuit 504 is described in detail below with respect to the timing diagram of FIG. 6.

Referring to FIG. 6, the input lines in0 to in(n−1) may have input data D₀(t) to Dₙ₋₁(t), respectively asserted thereon at a rising edge of the external clock clk (e.g., for clock cycle t in the illustrated example). Each of D₀(t) to Dₙ₋₁(t) may be a set of S values, where S is the number of lines in interface_in of the SCDD 100.

The input bridging circuit 502 may store the input data D₀(t) to Dₙ₋₁(t) for the duration of the clock cycle or the design interface 500b may be such that the input data D₀(t) to Dₙ₋₁(t) remains asserted by an external component for the duration of the clock cycle.

The input bridging circuit 502 serializes input data D₀(t) to Dₙ₋₁(t) by sequentially asserting input data D₀(t) to Dₙ₋₁(t) on the inputs (e.g., interface_in) of the TDM design 200 on rising edges of the sub-divided clock clkNx. For example, on each rising edge of the next N rising clock edges of clkNx, the first rising edge being simultaneous (e.g., within 2 ms) with the rising edge of the external clock clk, the input bridging circuit 502 may output another set of input data from the input data D₀(t) to Dₙ₋₁(t): rising edge 0→output D₀(t); rising edge 1, output D₁(t), . . . rising edge N−1, output Dₙ₋₁(t).

The output bridging circuit 504 deserializes output data Q₀(t) to Qₙ₋₁(t) output from the TDM design 200 (e.g., interface_out) on each rising edge of the sub-divided clock clkNx. The output bridging circuit 504 may therefore include a register (Bᵢ, i=0 to N−1) for each instance of the SCDD implemented by the TDM design 200. For example, for each rising edge of N rising edges of the sub-divided clock the output bridging circuit 504 may sequentially store the output of the TDM design 200 in a different output register: rising edge 0→store in B₀; rising edge 1, store in B₁, . . . rising edge N−1 store in B_{N-1}.

The outputs of the output registers may be asserted on the outputs (out0 to out(n−1)) of the bridging circuit on the last rising edge of the N rising edges, e.g., rising edge n−1, the rising edge on which the last output Qₙ₋₁(t) became valid. The outputs Q₀(t) to Qₙ₋₁(t) are therefore available to be latched into a storage element downstream from the design interface on the next rising edge of the external clock (e.g., clock cycle t+1).

As is apparent from the above description, an SCDD 100 may be automatically converted to a TDM design 200 in which only one instance of combinational logic 102 is present. The TDM design 200 will therefore occupy a smaller area of a silicon die, use fewer gates of an FPGA, or otherwise use less resources of whichever type of device implements the TDM design 200.

The TDM design 200 according to any of the embodiments disclosed herein may be in the form of an HDL file or other programming language for describing a circuit design. The TDM design 200 may then be converted to a netlist, which is then converted to a physical layout of transistors. The physical layout may then be fabricated on a silicon die to obtain an ASIC. In a like manner, a netlist generated from the TDM design 200 may be used to program an FPGA to implement the TDM design 200.

FIG. 7 illustrates an example computing device 700 that may be used to convert a digital logic design to a TDM design 200 or in which hardware implementing a TDM design 200 may be incorporated.

Computing device 700 includes one or more processor(s) 702, one or more memory device(s) 704, one or more interface(s) 706, one or more mass storage device(s) 708, one or more Input/Output (I/O) device(s) 710, and a display device 730 all of which are coupled to a bus 712. Processor(s) 702 include one or more processors or controllers that execute instructions stored in memory device(s) 704 and/or mass storage device(s) 708. Processor(s) 702 may also include various types of computer-readable media, such as cache memory.

Memory device(s) 704 include various computer-readable media, such as volatile memory (e.g., random access memory (RAM) 714) and/or nonvolatile memory (e.g., read-only memory (ROM) 716). Memory device(s) 704 may also include rewritable ROM, such as Flash memory.

Mass storage device(s) 708 include various computer readable media, such as magnetic tapes, magnetic disks, optical disks, solid-state memory (e.g., Flash memory), and so forth. As shown in FIG. 7, a particular mass storage device is a hard disk drive 724. Various drives may also be included in mass storage device(s) 708 to enable reading from and/or writing to the various computer readable media. Mass storage device(s) 708 include removable media 726 and/or non-removable media.

I/O device(s) 710 include various devices that allow data and/or other information to be input to or retrieved from computing device 700. Example I/O device(s) 710 include cursor control devices, keyboards, keypads, microphones, monitors or other display devices, speakers, printers, network interface cards, modems, lenses, CCDs or other image capture devices, and the like.

Display device 730 includes any type of device capable of displaying information to one or more users of computing device 700. Examples of display device 730 include a monitor, display terminal, video projection device, and the like.

Interface(s) 706 include various interfaces that allow computing device 700 to interact with other systems, devices, or computing environments. Example interface(s) 706 include any number of different network interfaces 720, such as interfaces to local area networks (LANs), wide area networks (WANs), wireless networks, and the Internet. Other interface(s) include user interface 718 and peripheral device interface 722. The interface(s) 706 may also include one or more user interface elements 718. The interface(s) 706 may also include one or more peripheral interfaces such as interfaces for printers, pointing devices (mice, track pad, etc.), keyboards, and the like.

Bus 712 allows processor(s) 702, memory device(s) 704, interface(s) 706, mass storage device(s) 708, and I/O device(s) 710 to communicate with one another, as well as other devices or components coupled to bus 712. Bus 712 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 700, and are executed by processor(s) 702. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents.

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

1. A method comprising:
receiving, by a computer system, an original design comprising:
combinational logic having external interface inputs, external interface outputs, state interface inputs, and state interface outputs, the combinational logic being stateless; and
data storage having state outputs coupled to the state interface inputs, state inputs coupled to the state interface outputs, and a clock input, the data storage configured to store a plurality of states and output the plurality of states on the state outputs, the data storage further configured to set the plurality of states according to values on the state inputs for each clock cycle received on the clock input; and
generating, by the computer system, a time-division multiplexed (TDM) design based on the original design, the TDM design including:
a single instance of the combinational logic;
a chain of instances of the data storage configured such that:
a first instance of the chain of instances has the state inputs thereof coupled to the state interface outputs of the single instance of the combinational logic;
a last instance of the chain of instances has the state outputs thereof coupled to the state interface inputs of the single instance of the combinational logic; and
all instances of the chain of instances other than the first instance have the state inputs thereof coupled to the state outputs of a preceding instance of the chain of instances.

2. The method of claim 1, wherein the data storage comprises a set of flip flops and each instance of the chain of instances includes an instance of the set of flip flops.

3. The method of claim 1, wherein the clock input of each instance of the chain of instances is coupled to a sub-divided clock configured to generate N clock cycles for each clock cycle of an external clock, where N is a number of instances in the chain of instances.

4. The method of claim 3, wherein generating the TDM design further comprises:
generating, by the computer system, an input bridging circuit configured to sequentially input sets of external inputs to the external interface inputs of the combinational logic, one set of the sets of external inputs for each cycle of the sub-divided clock; and
generating, by the computer system, an output bridging circuit configured to sequentially store outputs of the combinational logic to the external interface outputs in one of a plurality of registers for each cycle of the sub-divided clock and output data from the plurality of registers for each clock cycle of the external clock.

5. The method of claim 1, wherein the combinational logic includes a plurality of logic gates including at least one of AND, NAND, OR, NOR, XOR, and XNOR.

6. The method of claim 1, wherein the original design and the TDM design each comprise one or more hardware description language (HDL) files.

7. The method of claim 6, further comprising:
generating a netlist from the TDM design;
generating a physical layout from the netlist; and
fabricating an application specific integrated circuit (ASIC) implementing the TDM design.

8. The method of claim 1, further comprising:
generating a netlist from the TDM design; and
programming gates of a field programmable gate array (FPGA) to implement the netlist.

9. A non-transitory computer-readable medium storing executable code that, when executed by one or more processing devices, causes the one or more processing devices to:
receive an original design comprising:
combinational logic having external interface inputs, external interface outputs, state interface inputs, and state interface outputs, the combinational logic being stateless; and
data storage having state outputs coupled to the state interface inputs, state inputs coupled to the state interface outputs, and a clock input, the data storage configured to store a plurality of states and output the plurality of states on the state outputs, the data storage further configured to set the plurality of states according to values on the state inputs for each clock cycle received on the clock input; and
generate a time-division multiplexed (TDM) design based on the original design, the TDM design including:
a single instance of the combinational logic;
a chain of instances of the data storage configured such that:
a first instance of the chain of instances has the state inputs thereof coupled to the state interface outputs of the single instance of the combinational logic;
a last instance of the chain of instances has the state outputs thereof coupled to the state interface inputs of the single instance of the combinational logic; and
all instances of the chain of instances other than the first instance have the state inputs thereof coupled to the state outputs of a preceding instance of the chain of instances.

10. The non-transitory computer-readable medium of claim 9, wherein the data storage comprises a set of flip flops and each instance of the chain of instances includes an instance of the set of flip flops.

11. The non-transitory computer-readable medium of claim 9, wherein the clock input of each instance of the chain of instances is coupled to a sub-divided clock configured to generate N clock cycles for each clock cycle of an external clock, where N is a number of instances in the chain of instances.

12. The non-transitory computer-readable medium of claim 11, wherein the executable code, when executed by one or more processing devices, further causes the one or more processing devices to generate the TDM design by:
generating an input bridging circuit configured to sequentially input sets of external inputs to the external interface inputs of the combinational logic, one set of the sets of external inputs for each cycle of the sub-divided clock; and
generating an output bridging circuit configured to store outputs of the combinational logic to the external interface outputs in one of a plurality of registers in sequence for each cycle of the sub-divided clock and output data from the plurality of registers for each clock cycle of the external clock.

13. The non-transitory computer-readable medium of claim 9, wherein the combinational logic includes a plurality of logic gates including at least one of AND, NAND, OR, NOR, XOR, and XNOR.

14. The non-transitory computer-readable medium of claim 9, wherein the original design and the TDM design each comprise one or more hardware description language (HDL) files.

15. An apparatus comprising:
combinational logic having external interface inputs, external interface outputs, state interface inputs, and state interface outputs, the combinational logic being stateless; and
a chain of instances of data storage, each instance of the data storage:
having state outputs coupled to the state interface inputs, state inputs coupled to the state interface outputs, and a clock input;
being configured to store a plurality of states and output the plurality of states on the state outputs; and
being configured to set the plurality of states according to values on the state inputs for each clock cycle received on the clock input; and
wherein the chain of instances of the data storage is configured such that:
a first instance of the chain of instances has the state inputs thereof coupled to the state interface outputs of the combinational logic;
a last instance of the chain of instances has the state outputs thereof coupled to the state interface inputs of the combinational logic; and
all instances of the chain of instances other than the first instance have the state inputs thereof coupled to the state outputs of a preceding instance of the chain of instances.

16. The apparatus of claim 15, wherein the data storage comprises a set of flip flops and each instance of the chain of instances includes an instance of the set of flip flops.

17. The apparatus of claim 15, further comprising an external clock and a sub-divided clock configured to generate N clock cycles for each clock cycle of the external clock, where N is a number of instances in the chain of instances;
wherein the clock input of each instance of the chain of instances is coupled to the sub-divided clock.

18. The apparatus of claim 17, further comprising:
an input bridging circuit configured to sequentially input sets of external inputs to the external interface inputs of the combinational logic, one set of the sets of external inputs for each cycle of the sub-divided clock; and
configured to sequentially store outputs of the combinational logic to the external interface outputs in one of a plurality of registers for each cycle of the sub-divided clock and output data from the plurality of registers for each clock cycle of the external clock.

19. The apparatus of claim 15, wherein the combinational logic includes a plurality of logic gates including at least one of AND, NAND, OR, NOR, XOR, and XNOR.

20. The apparatus of claim 15, wherein the combinational logic and chain of instances of the data storage are implemented in one of a silicon die and a field programmable gate array.
